(19) United States
(12) Patent Application Publication
(10) Pub. No.: US 2003/0198504 A1
(43) Pub. Date: Oct. 23, 2003

(54) Three-ring loose-leaf binder for two paper sizes

(76) Inventor: Florence Hyman, Oceanside, NY (US)

Correspondence Address: MYRON AMER, P.C., Suite 310, 114 Old Country Road, Mineola, NY, 11501, US

(21) Appl. No.: 10/124,157

(22) Filed: Apr. 18, 2002

(51) Int. Cl. B42F 3/00

(52) U.S. Cl. 402/1

(57) ABSTRACT

A three-ring loose-leaf binder for accommodating both three-hole and four-hole punched 8½ inch wide and, respectively, 11 and 14-inch long sheets in which the four-hole punched sheets are supplemented by three-hole punches correlated to the binder's three-hole ring locations and thus also to the punched locations of the 8½ by 11 sheets, and the size of the binder is correlated to the size of the 8½ by 14 sheets.

The present invention relates generally to improvements in a loose-leaf ring binder for record keeping and like business purposes in which, more particularly, the improvements enable the commingling in a single binder the two popular sizes of punched and lined loose-leaf sheets.

### EXAMPLE OF THE PRIOR ART

The versatility of a ring binder in which punched-hole sheets can be inserted into, and when required, removed from by merely opening and closing of the rings engaging the punched holes, has popularized the use of the binder. In addition to changing the number of sheets accommodated, efforts have also been made to vary the nature of the sheets accommodated such as, for example, U.S. Pat. No. 3,145,034 for “Combined Check And Account Book” issued to Campbell on Aug. 18, 1964, in which two end-uses of sheets are accommodated in a single binder, in accordance with a coincidence that each end-use sheet as made commercially available is similarly punched and thus the punched holes therein readily are correlated to the locations of the rings in the binder.

As known by common experience however, punched hole locations differ in different sizes of sheets that a user would want to accommodate in a single binder, and the correlating of punched hole locations to the ring locations of a single binder has thus remained needlessly unresolved because it is believed, that the commercially punched holes are believed to interfere with hole-location modification that would provide the needed correlation.

Broadly, it is an object of the present invention to overcome the foregoing invalid beliefs and other shortcomings of the prior art by using to advantage popular and readily available hole-punching technology.

More particularly, it is an object to put into practice the understanding that in the different most popular sizes of loose-leaf sheets there are available sites of punching thereon at which there is no paper substrate removal that is duplicative of paper substrate removal that resulted in the commercially punched holes, i.e., one hole punched onto another hole, and thus obtaining a commercially punched sheet with supplementary punched holes to enable accommodation in a single loose-leaf binder.

The description of the invention which follows, together with the accompanying drawings should not be construed as limiting the invention to the example shown and described, because those skilled in the art to which this invention appertains will be able to devise other forms thereof within the ambit of the appended claims.

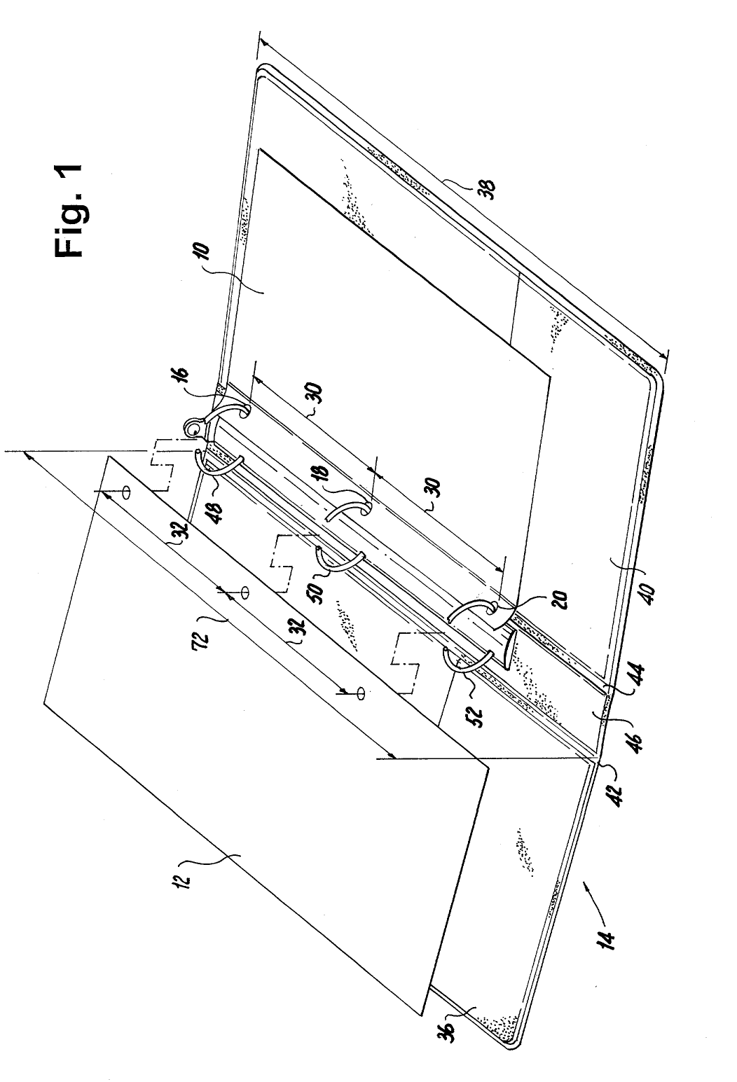

FIG. 1 is a perspective front elevational view of a loose-leaf binder according to the present invention;

FIG. 2 is a partial front elevational view showing details of the 3-hole ring means thereof;

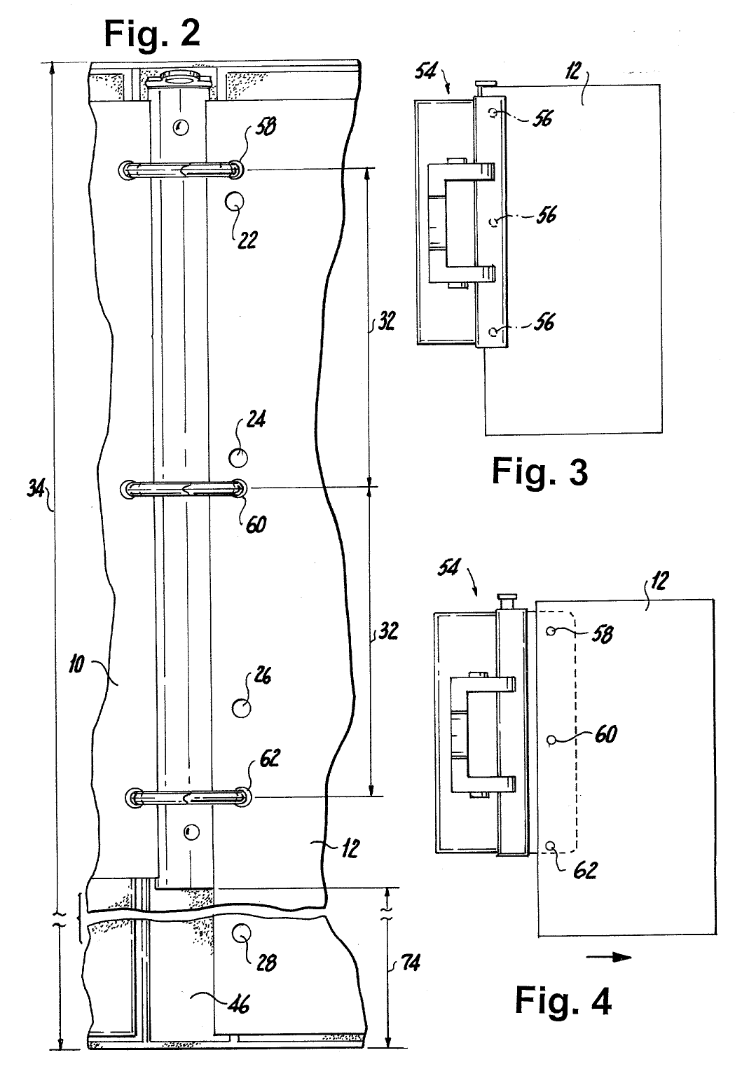

FIG. 3 is a plan view, on a reduced scale, of a 3-hole punch used in preparing 8½ by 14 loose-leaf sheets for the loose-leaf binder of FIG. 1; and

FIG. 4 is a view similar to FIG. 3 illustrating the prepared 8½ by 14 loose-leaf sheets.

There are two commercially available standard sized lined loose-leaf sheets for record keeping and like business purposes, one 8½ by 11 inch sized sheets, herein individually and collectively designated 10, and the other 8½ by 14 inch sized sheets, typically called legal size sheets herein also individually and collectively designated 12. As their name implies the sheets 10, 12 are removably placed in and removed, when desired, from a loose-leaf binder, generally designated 14, using three punched holes, 16, 18 and 20, in the smaller sheets 10 and four punched holes 22, 24, 26 and 28 in the larger sheets 12, the distances 30 being of standard dimensions therebetween, typically approximately four and one half inches and at opposite margins one inch for the sheets 10, and in the middle for the sheets 12, the distances 32 being of standard dimensions therebetween, typically approximately three inches and at opposite margins approximately one inch at the top and approximately four inches at the bottom.

Separate slightly oversized sheet-sized binders (not shown) were heretofore provided for the sheets 12 and likewise for the sheets 10. In accordance with the present invention there is now provided the single loose-leaf binder 14, using to advantage the recognition that the hole-punching for the three-hole format of the sheets 10 is readily accommodated in the hole format of the sheets 12, 50 that in the loose-leaf binder 14 the two sizes of sheets 10, 12 can be commingled, preferably extending in opposite directions from sites of attachment in the binder 14, as now to be described.

The binder 14 has a selected sized 34 front cover 36 and a selected sized 36 rear cover 40, the selected sizes 34, 36 being of an extent slightly oversized with respect to the 8½ by 14 inch sized sheets 12, the covers 36, 40 being attached to extend from opposite sides 42 and 44 of a spine 46 so as to partake of pivotal traverses in covering and uncovering relation to the sheets 10, 12 in turn attached to three, well known in construction and operating mode, ring means 48, 50, and 52 in the spine 46, the locations of the holes and rings being correlated with each other. To achieve the correlation of the three-rings 48, 50 and 52, to a punched hole format in the 8½ by 14 inch sheets 12, the four commercially punched holes 22, 24, 26 and 28 are not utilized and, instead, use is made of a standard hole-punching device 54 with punches 56 arranged to punch supplementing holes 58, 60 and 62 at distances 64 and 66 at upper opposite margins and 68 and 70 in the middle of the sheets 12, at which sites of punching there is no paper substrate removal that is duplicative of paper substrate removal that resulted in the commercially punched holes 22, 24, 26 and 28.

The larger loose-leaf sheets 12 are sometimes commercially available without a four-hole punched format, and thus this commercially available version is even more readily processed using the 3-hole punch device 54.

It is noted for completeness sake that the vertical size 72 of the spine 46 is slightly oversized beyond the 14 inch dimension of the larger sheet 12, having a lower extension 74 beyond the lower ring means 52.

While the apparatus for practicing the within inventive method, as well as said method herein shown and disclosed in detail is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claims.

What is claimed is:

1. In combination, a loose-leaf ring binder for a standard sized 8½ by 11 inch 3-hole punched sheets and a standard sized 8½ by 14 inch 4-hole punched sheets, comprising:
A. a selected sized front cover and a selected sized rear cover, said selected sizes of both said front and rear covers being of an extent slightly oversized with respect to said 8½ by 14 inch sheets so as to be in covering relation thereover, a spine of a selected length size with opposite sides having an operative interposed position between said front and rear covers in extended connected relation from each said opposite side of said spine, said selected length size of said spine being of an extent of approximately the same as said extent of oversize in relation of said 14 inch dimension of said 8½ by 14 inch sheets, a sheet-engaging 3-hole ring means disposed on said spine extending from an initial position adjacent a top of said front and rear covers and oriented lengthwise thereof; and
B. a selected standard sized 3-hole sheet punching means, said size thereof being selected to impart punched holes in sheets in locations coinciding with said punched holes in said 8½ by 11 punched hole sheets, and alternate supplementing punched holes imparted by said 3-hole sheet punching means to said 8½ by 14 inch sheets at said coinciding locations therein;
whereby between said front and rear covers said 8½ by 11 inch sheets are connected to said 3-hole rings to extend to one side of said binder and said 8½ by 14 inch sheets are similarly connected to said 3-hole rings using said alternate supplementing punched holes therein and to extend to an opposite side of said binder.

2. In combination, a loose-leaf ring binder for a standard sized 8½ by 11 inch 3-hole punched sheets and a standard sized unpunched 8½ by 14 inch paper sheets, comprising:
A. a selected sized front cover and a selected sized rear cover, said selected sizes of both said front and rear covers being of an extent slightly oversized with respect to said 8½ by 14 inch sheets so as to be in covering relation thereover, a spine of a selected length size with opposite sides having an operative interposed position between said front and rear covers in extended connected relation from each said opposite side of said spine, said selected length size of said spine being of an extent of approximately the same as said extent of oversize in relation of said 14 inch dimension of said 8½ by 14 inch sheets, a sheet-engaging 3-hole ring means disposed on said spine extending from an initial position adjacent a top of said front and rear covers and oriented lengthwise thereof; and
B. a selected standard sized 3-hole sheet punching means, said size thereof being selected to impart punched holes in sheets in locations coinciding with said punched holes in said 8½ by 11 punched hole sheets, and punched holes imparted by said 3-hole sheet punching means to said 8½ by 14 inch sheets at said coinciding locations therein;
whereby between said front and rear covers said 8½ by 11 inch sheets are connected to said 3-hole rings to extend to one side of said binder and said 8½ by 14 inch sheets are similarly connected to said 3-hole rings and to extend to an opposite side of said binder.
